(19) United States
(12) Patent Application Publication
(10) Pub. No.: US 2020/0010305 A1
(43) Pub. Date: Jan. 9, 2020

(54) SLING BARS FOR LIFTING SYSTEMS AND METHODS FOR OPERATING SLING BARS

(71) Applicant: Liko Research & Development AB, Luleå (SE)

(72) Inventor: Jesse Newman, Batesville, IN (US)

(73) Assignee: Liko Research & Development AB, Luleå (SE)

(21) Appl. No.: 16/458,803

(22) Filed: Jul. 1, 2019

Related U.S. Application Data
(60) Provisional application No. 62/694,740, filed on Jul. 6, 2018.

(51) Int. Cl. B66C 1/12; A61G 7/10

(52) U.S. Cl. CPC B66C 1/12; A61G 7/1078; A61G 7/1023

(57) ABSTRACT

A sling bar includes a bar extending between a first end and a second end, and a sling attachment member positioned at at least one of the first end and the second end, the sling attachment member including a bar attachment portion coupled to the bar, a lift hook extending outward from the bar attachment portion, the lift hook defining an upward-facing opening, and a latch member pivotally coupled to one of the bar attachment portion or the lift hook, where the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

### CROSS-REFERENCE TO RELATED APPLICATIONS

This application claims the benefit of U.S. Provisional Patent Application Ser. No. 62/694,740, entitled “Sling Bars for Lifting Systems and Methods for Operating Sling Bars” and filed Jul. 6, 2018, the contents of which are incorporated by reference herein in their entirety.

### FIELD

The present specification generally relates to sling bars and, in particular to sling bars for subject lifting systems, such as mobile lifts and/or overhead lifts, and methods for operating the same.

### TECHNICAL BACKGROUND

Subject lifting systems, such as mobile lifts and overhead lifts, are used to transport a subject for any number of reasons. Overhead lifts may operate like a winch and include a lift motor and a lift drum that is driven by the lift motor. A lift strap may be coupled to the lift drum for lifting and lowering a subject when the drum is rotated and the lift strap is either wound up onto the lift drum, or paid out from the lift drum.

As another example, mobile lifts may include a lift device positioned on one or more wheels to transport a subject from one location to another. A sling bar may be attached to the overhead lifts and the mobile lifts to connect a subject to the overhead lift or the mobile lift, such as by a sling, a vest, or the like attached to the sling bar.

Some conventional sling bars may require a user, such as a caregiver, to manipulate a sling attachment portion of the sling bar to attach a sling, a vest, or the like to the sling bar. Conventional sling bar attachment portions may require the use of both hands to manipulate the attachment portion to securely attach the sling or vest to the sling bar attachment portion, and it may be difficult to attach the sling or vest to the sling bar attachment portion while simultaneously manipulating the sling bar attachment portion.

Accordingly, a need exists for alternative sling bar attachment portions that may be manipulated with one hand to securely attach a sling or vest to the sling bar attachment portion.

### SUMMARY

In one embodiment, a sling bar includes a bar extending between a first end and a second end, and a sling attachment member positioned at at least one of the first end and the second end, the sling attachment member including a bar attachment portion coupled to the bar, a lift hook extending outward from the bar attachment portion, the lift hook defining an upward-facing opening, and a latch member pivotally coupled to one of the bar attachment portion or the lift hook, where the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

In another embodiment, a subject support lift includes a lift actuator, a sling bar operatively coupled to the lift actuator, the sling bar including a bar extending between a first end and a second end, and a sling attachment member positioned at at least one of the first end and the second end, the sling attachment member including a bar attachment portion coupled to the bar, a lift hook extending outward from the bar attachment portion, the lift hook defining an upward-facing opening, and a latch member pivotally coupled to one of the bar attachment portion or the lift hook, where the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

In yet another embodiment, a method for attaching a sling to a subject support lift includes attaching a sling bar to the subject support lift, the sling bar including a bar and a sling attachment member coupled to the bar, pivoting a latch member of the sling attachment member about a pivot member from a closed position, in which the latch member extends across an upward-facing opening defined by a lift hook of the sling attachment member, to an open position, in which the latch member is spaced apart from the upward-facing opening, positioning a loop of the sling within the lift hook of the sling attachment member, and pivoting the latch member of the sling attachment member from the open position to the closed position.

Additional features of the sling bar devices and methods for operating the sling bar devices described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a front view of a sling bar including sling attachment portions, according to one or more embodiments shown and described herein;

FIG. 2 schematically depicts an enlarged perspective view of a sling attachment portion of FIG. 1 in an open position, according to one or more embodiments shown and described herein;

FIG. 3 schematically depicts an enlarged perspective view of the sling attachment portion of FIG. 2 in a closed position, according to one or more embodiments shown and described herein;

FIG. 4 schematically depicts an enlarged view of a latch member of the sling attachment portion of FIG. 3 in the closed position, according to one or more embodiments shown and described herein;

FIG. 5 schematically depicts an enlarged perspective view of the sling attachment portion of FIG. 3 attached to a loop of a sling, according to one or more embodiments shown and described herein; and

FIG. 6 schematically depicts the sling bar of FIG. 1 attached to a subject support lift, according to one or more embodiments shown and described herein.

### DETAILED DESCRIPTION

Reference will now be made in detail to embodiments of sling bars for person lifting devices and methods of operating the same, examples of which are illustrated in the accompanying drawings. Whenever possible, the same reference numerals will be used throughout the drawings to refer to the same or like parts. Embodiments described herein are directed to sling bars including a sling attachment member coupled to a bar, the sling bar attachment member including a bar attachment portion coupled to the bar, and a lift hook extending outward from the bar attachment portion. The lift hook generally defines an upward-facing opening, in which a loop of a sling may be positioned to connect the sling to the sling bar. The sling attachment member further includes a latch member that is selectively repositionable between a closed position, in which the latch member extends across an upward-facing opening defined by the lift hook, and an open position, in which the latch member is spaced apart from the upward-facing opening. The latch member may be manipulated with one hand, assisting a caregiver in connecting the sling to the sling bar. The lift hook may also assist in retaining the loop of the sling within the lift hook to maintain a connection between the sling and the sling bar. Various embodiments of sling bar devices for person lifting devices and methods for operating the same will be described herein with specific reference to the appended drawings.

As used herein, the term “longitudinal direction” refers to the forward-rearward direction of the sling bar (i.e., in the +/−X-direction as depicted). The term “lateral direction” refers to the cross-direction of the sling bar (i.e., in the +/−Y-direction as depicted), and is transverse to the longitudinal direction. The term “vertical direction” refers to the upward-downward direction of the sling bar (i.e., in the +/−Z-direction as depicted), and is transverse to the lateral and the longitudinal directions.

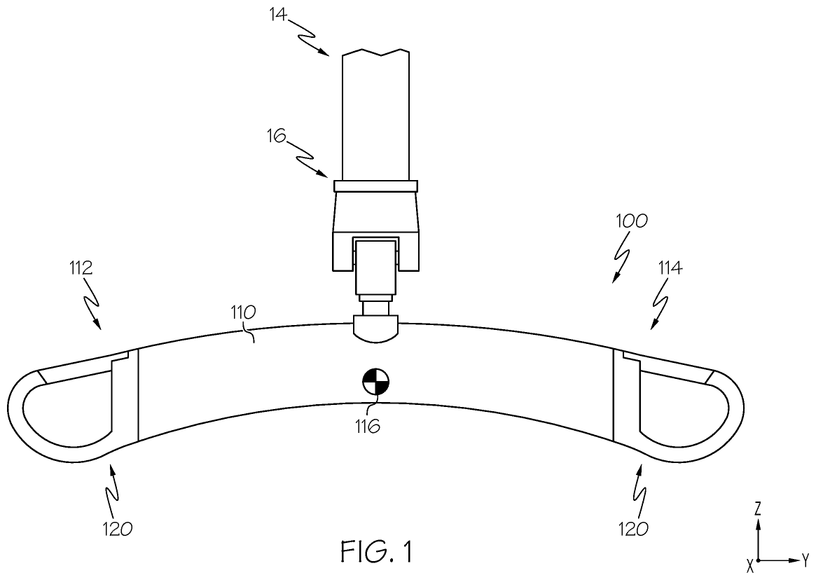

Referring initially to FIG. 1, a front view of an example sling bar 100 is depicted. The sling bar 100 generally includes a bar 110 that extends between a first end 112 and a second end 114 in the lateral direction. In embodiments, the bar 110 includes a center 116 that is positioned between the first end 112 and the second end 114. As used herein the terms “inboard” and “outboard” refer to the relative positioning of components of the sling bar 100 with respect to the center 116 of the bar 110. In the embodiment depicted in FIG. 1, the sling bar 100 includes sling attachment members 120 that are coupled to the first end 112 and the second end 114 of the bar 110. The sling attachment members 120 may selectively couple a sling, a vest, or the like to the sling bar 100, as described in greater detail herein.

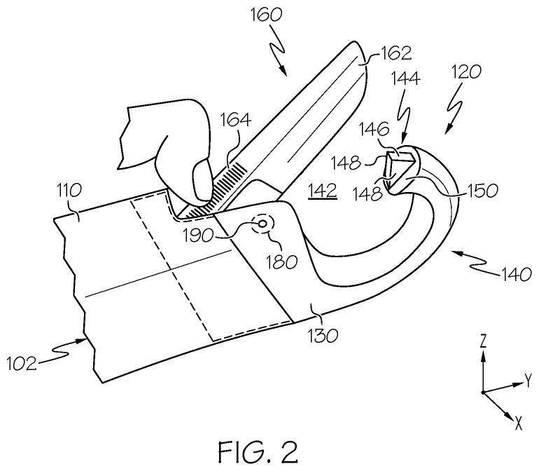

Referring to FIG. 2, an enlarged perspective view of one of the sling attachment members 120 is depicted. The sling attachment member 120 generally includes a bar attachment portion 130, a lift hook 140 extending outward from the bar attachment portion 130, and a latch member 160. The bar attachment portion 130 is coupled to the bar 110, and in some embodiments, at least a portion of the bar attachment portion 130 may extend into a cavity 102 defined by the bar 110. In some embodiments, the bar attachment portion 130 may be selectively coupled to the bar 110, such that sling attachment member 120 may be removable from the bar 110 in a non-destructive fashion, such that sling attachment members 120 may be removed and replaced from the bar 110. In other embodiments, the bar attachment portion 130 may be fixedly attached to the bar 110, such that the sling attachment member 120 is not generally removable from the bar 110. The bar attachment portion 130 may be coupled to the bar 110 in any suitable manner, such as by mechanical fasters, welding, brazing, or structural adhesives.

The lift hook 140 extends outward from the bar attachment portion 130 in the lateral direction as depicted. The lift hook 140 generally extends outward in the lateral direction and upward in the vertical direction, defining an upward-facing opening 142 that permits access to an interior bounded by the lift hook 140. Loops of a sling may be positioned on the lift hook 140, such as by placing a portion of the loop through the upward-facing opening 142, as described in greater detail herein.

In the embodiment depicted in FIG. 2, the latch member 160 is pivotally coupled to the bar attachment portion 130 of the sling attachment member 120 at a pivot member 190. In general, the pivot member 190 may include a pin coupled to the latch member 160 and the bar attachment portion 130, such that the latch member 160 is rotatable with respect to the bar attachment portion 130 about the pivot member 190. While in the embodiment depicted in FIG. 2 the latch member 160 is pivotally coupled to the bar attachment portion 130, in other embodiments, the latch member 160 may be pivotally coupled to the lift hook 140 and may be selectively engageable with the bar attachment portion 130.

The latch member 160 generally includes a lever portion 164 and a tongue portion 162 that extends outward from the tongue portion 162 in the lateral direction. In the embodiment depicted in FIG. 2, the lever portion 164 is positioned inboard of the pivot member 190 and the tongue portion 162 is positioned outboard of the pivot member 190, such that depression of the lever portion 164 causes the latch member 160 to rotate about the pivot member 190 to move the tongue portion 162 upward in the vertical direction.

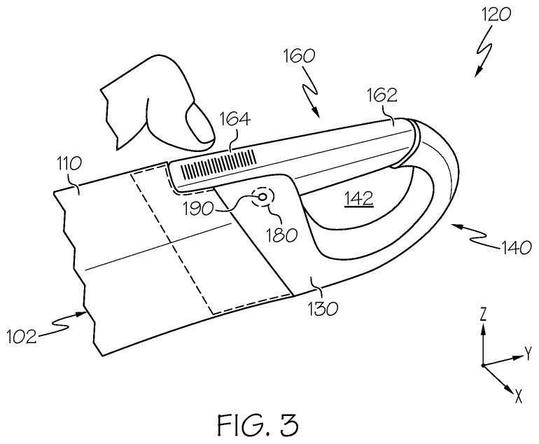

Referring collectively to FIGS. 2 and 3, the latch member 160 is repositionable between an open position, as shown in FIG. 2, and a closed position, as shown in FIG. 3. In the open position, the latch member 160 is spaced apart from the lift hook 140 and the upward-facing opening 142, such that a loop of a sling may be positioned on the lift hook 140. In the closed position, the latch member 160 extends across the upward-facing opening 142 and engages the lift hook 140. More particularly, in the closed position, the tongue portion 162 of the latch member 160 extends across the upward-facing opening 142 and engages the lift hook 140.

The latch member 160 may be repositionable from the closed position to the open position by depressing the lever portion 164, causing the latch member 160 to rotate about the pivot member 190 moving the tongue portion 162 upward in the vertical direction away from the upward facing-opening 142. In embodiments, the latch member 160 is repositionable from the closed position to the open position by a user depressing the lever portion 164 downward in the vertical direction with a single digit, for example a user's thumb, such that the user may manipulate the latch member 160 from the closed position to the open position with a single hand. Because a user may manipulate the latch member 160 with a single hand, the user's other hand is free to perform other tasks, such as manipulating a loop of a sling into the lift hook 140. In this way, the latch member 160 may reduce the burden on a user to secure a loop of a sling to the sling bar 100 as compared to conventional configurations, which may require both of a user's hands to secure the loop of the sling to the sling bar.

In some embodiments, the sling attachment member 120 includes a biasing member 180 that is engaged with the latch member 160 and biases the latch member 160 into the closed position. The biasing member 180 may include any suitable construction to bias the latch member 160 into the closed position, and may include a spring, such as a compression spring, a torsion spring, or an extension spring. In other embodiments, the biasing member 180 may be omitted, and the latch member 160 may be moved to the closed position from the open position under the force of gravity.

Referring particularly to FIG. 2, in embodiments in which the latch member 160 is pivotally coupled to the bar attachment portion 130, the lift hook 140 includes an engagement member 144 extending inward toward the upward-facing opening 142. The engagement member 144 includes an upward-facing contact face 146 that faces upward in the vertical direction, and at least one outward-facing contact face 148 that faces outward in the longitudinal direction. The at least one outward-facing contact face 148 generally extends in a plane that is transverse to the upward-facing contact face 146. In the embodiment depicted in FIG. 2, the engagement member 144 includes a pair of outward-facing contact faces 148 that are oriented to face in opposite directions in the longitudinal direction. When the latch member 160 is in the closed position, the tongue portion 162 of the latch member 160 engages the upward-facing contact face 146 and the at least one outward-facing contact face 148. For example, the tongue portion 162 may be shaped to receive and engage the engagement member 144 such that the tongue portion 162 engages the upward-facing contact face 146 and the at least one outward-facing contact face 148 of the engagement member 144. Engagement between the tongue portion 162 and the upward-facing contact face 146 may restrain downward movement of the tongue portion 162 in the vertical direction with respect to the engagement member 144, and accordingly may restrain downward movement of tongue portion 162 with respect to the lift hook 140. Furthermore, engagement between the tongue portion 162 and the at least one outward-facing contact face 148 may restrain movement of the tongue portion 162 in the longitudinal direction with respect to the engagement member 144, and accordingly may restrain movement of the tongue portion 162 with respect to the lift hook 140 in the longitudinal direction. By restraining movement of the tongue portion 162 in the vertical direction and the longitudinal direction, the upward-facing contact face 146 and the at least one outward-facing contact face 148 of the engagement member 144 may assist in retaining the latch member 160 in the closed position to retain a loop of a sling within the lift hook 140. While the engagement member 144 is described and depicted as extending inward from the lift hook 140, in embodiments in which the latch member 160 is pivotally coupled to the lift hook 140 and extends inward from the lift hook 140, the engagement member 144 may be positioned on and extend outward from the bar attachment portion 130.

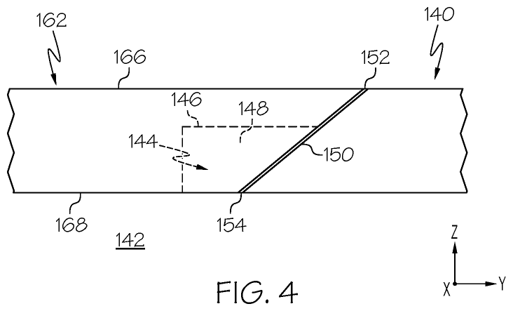

Referring collectively to FIGS. 2 and 4, a perspective view of the sling attachment member 120 and an enlarged view of the tongue portion 162 of the latch member 160 engaged with the engagement member 144 are schematically depicted, respectively. The lift hook 140 defines an inward facing surface 150 that is oriented to face toward the bar attachment portion 130 in the lateral direction. The inward-facing surface 150 includes a top end 152 and a bottom end 154 that is positioned below the top end 152 in the vertical direction. In embodiments, the top end 152 of the inward-facing surface 150 is positioned farther away from the bar attachment portion 130 in the lateral direction than the bottom end 154, such that the inward-facing surface 150 faces both inward in the lateral direction and upward in the vertical direction. Because the inward-facing surface 150 is both inward and upward facing, the inward-facing surface 150 may, along with the engagement member 144, restrict movement of the latch member 160 downward in the vertical direction when the latch member 160 is positioned in the closed position.

In embodiments, the tongue portion 162 of the latch member 160 is shaped to complement the inward-facing surface 150 of the lift hook 140. In particular, the latch member 160 includes a top end 166 and a bottom end 168 positioned below the top end 166 in the vertical direction, where the top end 166 extends farther outward from the bar attachment portion 130 than the bottom end 168. In this way, the tongue portion 162 of the latch member 160 may form a surface that is complementary to the inward facing surface 150 of the lift hook 140.

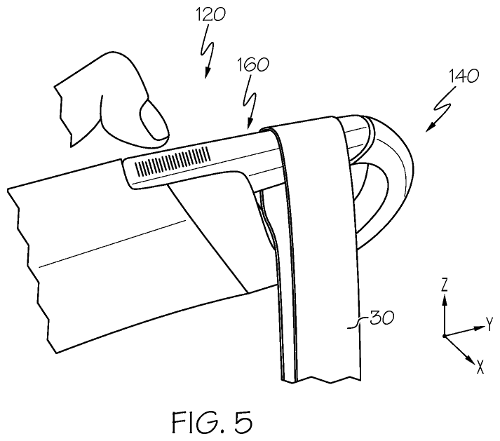

Referring to FIG. 5, the sling attachment member 120 is depicted with a loop 30 of a sling positioned in the lift hook 140. In the configuration depicted in FIG. 5, the loop 30 is positioned on the latch member 160 of the bar attachment portion 130 and extends through the lift hook 140. While it is desirable to seat the loop 30 within the lift hook 140 (i.e., so that the loop 30 is positioned below the latch member 160 and the loop 30 is fully supported by the lift hook 140), the sling attachment member 120 of the present disclosure may support the loop 30, even when the loop 30 is incorrectly positioned on the latch member 160. For example and as described above, in embodiments, the lift hook 140 includes the engagement member 144 (FIG. 2) that resists downward and longitudinal movement of the latch member 160 with respect to the lift hook 140, and the lift hook 140 further includes the inward facing surface 150 (FIG. 2) that also resists downward movement of the latch member 160 with respect to the lift hook 140. In this way, the latch member 160 may support weight applied to the loop 30 (such as may be applied by a subject positioned in a sling attached to the loop 30), and may maintain the positioning of the loop 30 within the lift hook 140.

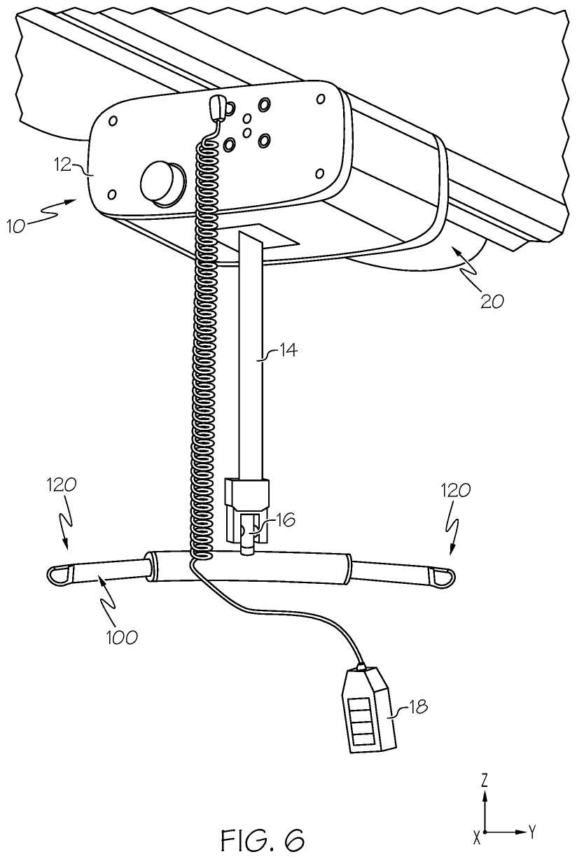

Referring to FIG. 6, a perspective view of a subject support lift 10 is schematically depicted. The subject support lift 10 generally includes a lift actuator 12 that is connected to a strap 14 that may be paid out or taken up by the lift actuator 12 in the vertical direction. In embodiments, the lift actuator 12 may include any suitable device for paying out and taking up the strap 14 in the vertical direction, such as an electric motor, a pneumatically powered device, a hydraulically powered device, or the like. A controller 18 is communicatively coupled to the lift actuator 12, and may be utilized by a user to control the operation of the lift actuator 12. In embodiments, the controller 18 may send signals to the lift actuator 12 causing the lift actuator to pay out or take up the strap 14 in the vertical direction. The subject support lift 10 further includes a connector 16 coupled to the strap 14. The connector 16 may selectively couple the sling bar 100 to the strap 14. As described above, the sling bar 100 includes the sling attachment members 120 that may selectively couple a loop 30 (FIG. 5) of a sling to the sling bar 100. In this way, a subject may be connected to the lift actuator 12 through a sling attached to the sling bar 100, and the subject may be lifted in the vertical direction with the lift actuator.

It should now be understood that embodiments described herein are directed to sling bars including a sling attachment member coupled to a bar, the sling bar attachment member including a bar attachment portion coupled to the bar, and a lift hook extending outward from the bar attachment portion. The lift hook generally defines an upward-facing opening, in which a loop of a sling may be positioned to connect the sling to the sling bar. The sling attachment member further includes a latch member that is selectively repositionable between a closed position, in which the latch member extends across an upward-facing opening defined by the lift hook, and an open position, in which the latch member is spaced apart from the upward-facing opening. The latch member may be manipulated with one hand, assisting a caregiver in connecting the sling to the sling bar. The lift hook may also assist in retaining the loop of the sling within the lift hook to maintain a connection between the sling and the sling bar.

Embodiments can be described with reference to the following numbered clauses, with preferred features laid out in the dependent clauses:

1. A sling bar comprising a bar extending between a first end and a second end; and a sling attachment member positioned at at least one of the first end and the second end, the sling attachment member comprising: a bar attachment portion coupled to the bar; a lift hook extending outward from the bar attachment portion, the lift hook defining an upward-facing opening; and a latch member pivotally coupled to one of the bar attachment portion or the lift hook, wherein the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

2. The sling bar of the preceding clause, further comprising a biasing member coupled to the latch member, wherein the biasing member biases the latch member into the closed position.

3. The sling bar of clause 1 or 2, wherein the bar attachment portion is selectively coupled to and positioned within a cavity of the bar.

4. The sling bar of any of clauses 1-3, wherein the latch member is pivotally coupled to the bar attachment portion at a pivot member.

5. The sling bar of clause 4, wherein the latch member comprises a lever portion positioned inboard of the pivot member and a tongue portion that extends across the upward-facing opening in the closed position.

6. The sling bar of clause 5, wherein the lift hook comprises an engagement member extending inward toward the upward-facing opening, the engagement member comprising an upward-facing contact face, wherein the tongue portion of the latch member engages the upward-facing contact face in the closed position.

7. The sling bar of clause 6, wherein the engagement member further comprises an outward-facing contact face that extends in a plane that is transverse to the upward-facing contact face, wherein the tongue portion of the latch member engages the outward-facing contact face in the closed position.

8. The sling bar of any of clauses 5-7, wherein the lift hook comprises an inward-facing surface that is oriented to face inward toward the bar attachment portion, the inward-facing surface comprising a top end and a bottom end positioned below the top end, wherein the top end is farther away from the bar attachment portion than the bottom end.

9. The sling bar of any of clauses 5-8, wherein the latch member comprises a top end and a bottom end positioned below the top end, wherein the top end extends farther outward from the bar attachment portion than the bottom end.

10. A subject support lift comprising: a lift actuator; a sling bar operatively coupled to the lift actuator, the sling bar comprising: a bar extending between a first end and a second end; and a sling attachment member positioned at at least one of the first end and the second end, the sling attachment member comprising: a bar attachment portion coupled to the bar; a lift hook extending outward from the bar attachment portion, the lift hook defining an upward-facing opening; and a latch member pivotally coupled to one of the bar attachment portion or the lift hook, wherein the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

11. The subject support lift of the preceding clause, further comprising a biasing member coupled to the latch member, wherein the biasing member biases the latch member into the closed position.

12. The subject support lift of clause 10 or 11, wherein the latch member is pivotally coupled to the bar attachment portion at a pivot member.

13. The subject support lift of clause 12, wherein the latch member comprises a lever portion positioned inboard of the pivot member and a tongue portion that extends across the upward-facing opening in the closed position.

14. The subject support lift of clause 13, wherein the lift hook comprises an engagement member extending inward toward the upward-facing opening, the engagement member comprising an upward-facing contact face, wherein the tongue portion of the latch member engages the upward-facing contact face in the closed position.

15. The subject support lift of clause 14, wherein the engagement member further comprises an outward-facing contact face that extends in a plane that is transverse to the upward-facing contact face, wherein the tongue portion of the latch member engages the outward-facing contact face in the closed position.

16. The subject support lift of any of clauses 13-15, wherein the lift hook comprises an inward-facing surface that is oriented to face inward toward the bar attachment portion, the inward-facing surface comprising a top end and a bottom end positioned below the top end, wherein the top end is farther away from the bar attachment portion than the bottom end.

17. The subject support lift of any of clauses 13-16, wherein the latch member comprises a top end and a bottom end positioned below the top end, wherein the top end extends farther outward from the bar attachment portion than the bottom end.

18. A method for attaching a sling to a subject support lift, the method comprising: attaching a sling bar to the subject support lift, the sling bar comprising a bar and a sling attachment member coupled to the bar; pivoting a latch member of the sling attachment member about a pivot member from a closed position, in which the latch member extends across an upward-facing opening defined by a lift hook of the sling attachment member, to an open position, in which the latch member is spaced apart from the upward-facing opening; positioning a loop of the sling within the lift hook of the sling attachment member; and pivoting the latch member of the sling attachment member from the open position to the closed position.

19. The method of the preceding clause, wherein pivoting the latch member from the closed position to the open position comprises depressing a lever portion of the latch member that is positioned inboard of the pivot member.

20. The method of clause 18 or 19, wherein pivoting the latch member from the open position to the closed position comprises engaging a tongue portion of the latch member with an engagement member of the lift hook that extends inward toward the upward-facing opening.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A sling bar comprising:
a bar extending between a first end and a second end; and
a sling attachment member positioned at at least one of the first end and the second end, the sling attachment member comprising:
a bar attachment portion coupled to the bar;
a lift hook extending outward from the bar attachment portion, the lift hook defining an upward-facing opening; and
a latch member pivotally coupled to one of the bar attachment portion or the lift hook, wherein the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

2. The sling bar of claim 1, further comprising a biasing member coupled to the latch member, wherein the biasing member biases the latch member into the closed position.

3. The sling bar of claim 1, wherein the bar attachment portion is selectively coupled to and positioned within a cavity of the bar.

4. The sling bar of claim 1, wherein the latch member is pivotally coupled to the bar attachment portion at a pivot member.

5. The sling bar of claim 4, wherein the latch member comprises a lever portion positioned inboard of the pivot member and a tongue portion that extends across the upward-facing opening in the closed position.

6. The sling bar of claim 5, wherein the lift hook comprises an engagement member extending inward toward the upward-facing opening, the engagement member comprising an upward-facing contact face, wherein the tongue portion of the latch member engages the upward-facing contact face in the closed position.

7. The sling bar of claim 6, wherein the engagement member further comprises an outward-facing contact face that extends in a plane that is transverse to the upward-facing contact face, wherein the tongue portion of the latch member engages the outward-facing contact face in the closed position.

8. The sling bar of claim 7, wherein the lift hook comprises an inward-facing surface that is oriented to face inward toward the bar attachment portion, the inward-facing surface comprising a top end and a bottom end positioned below the top end, wherein the top end is farther away from the bar attachment portion than the bottom end.

9. The sling bar of claim 5, wherein the latch member comprises a top end and a bottom end positioned below the top end, wherein the top end extends farther outward from the bar attachment portion than the bottom end.

10. A subject support lift comprising:
a lift actuator;
a sling bar operatively coupled to the lift actuator, the sling bar comprising:
a bar extending between a first end and a second end; and
a sling attachment member positioned at at least one of the first end and the second end, the sling attachment member comprising:
a bar attachment portion coupled to the bar;
a lift hook extending outward from the bar attachment portion, the lift hook defining an upward-facing opening; and
a latch member pivotally coupled to one of the bar attachment portion or the lift hook, wherein the latch member is repositionable between a closed position, in which the latch member extends across the upward-facing opening and engages the other of the lift hook or the bar attachment portion, and an open position, in which the latch member is spaced apart from the upward-facing opening and the other of the lift hook or the bar attachment portion.

11. The subject support lift of claim 10, further comprising a biasing member coupled to the latch member, wherein the biasing member biases the latch member into the closed position.

12. The subject support lift of claim 10, wherein the latch member is pivotally coupled to the bar attachment portion at a pivot member.

13. The subject support lift of claim 12, wherein the latch member comprises a lever portion positioned inboard of the pivot member and a tongue portion that extends across the upward-facing opening in the closed position.

14. The subject support lift of claim 13, wherein the lift hook comprises an engagement member extending inward toward the upward-facing opening, the engagement member comprising an upward-facing contact face, wherein the tongue portion of the latch member engages the upward-facing contact face in the closed position.

15. The subject support lift of claim 14, wherein the engagement member further comprises an outward-facing contact face that extends in a plane that is transverse to the upward-facing contact face, wherein the tongue portion of the latch member engages the outward-facing contact face in the closed position.

16. The subject support lift of claim 15, wherein the lift hook comprises an inward-facing surface that is oriented to face inward toward the bar attachment portion, the inward-facing surface comprising a top end and a bottom end positioned below the top end, wherein the top end is farther away from the bar attachment portion than the bottom end.

17. The subject support lift of claim 16, wherein the latch member comprises a top end and a bottom end positioned below the top end, wherein the top end extends farther outward from the bar attachment portion than the bottom end.

18. A method for attaching a sling to a subject support lift, the method comprising:
attaching a sling bar to the subject support lift, the sling bar comprising a bar and a sling attachment member coupled to the bar;
pivoting a latch member of the sling attachment member about a pivot member from a closed position, in which the latch member extends across an upward-facing opening defined by a lift hook of the sling attachment member, to an open position, in which the latch member is spaced apart from the upward-facing opening;
positioning a loop of the sling within the lift hook of the sling attachment member; and
pivoting the latch member of the sling attachment member from the open position to the closed position.

19. The method of claim 18, wherein pivoting the latch member from the closed position to the open position comprises depressing a lever portion of the latch member that is positioned inboard of the pivot member.

20. The method of claim 18, wherein pivoting the latch member from the open position to the closed position comprises engaging a tongue portion of the latch member with an engagement member of the lift hook that extends inward toward the upward-facing opening.
